(19) United States
(12) Patent Application Publication
(10) Pub. No.: US 2020/0310331 A1
(43) Pub. Date: Oct. 1, 2020

(54) CLEANING UNIT, CARTRIDGE, AND IMAGE FORMING APPARATUS

(71) Applicant: CANON KABUSHIKI KAISHA, Tokyo (JP)

(72) Inventors: Shun Sato, Minamiashigara-shi (JP); Kohei Matsuda, Fujisawa-shi (JP); Kazunori Hashimoto, Numazu-shi (JP)

(21) Appl. No.: 16/820,758

(22) Filed: Mar. 17, 2020

(30) Foreign Application Priority Data
Mar. 29, 2019 (JP) 2019-068045

(51) Int. Cl. G03G 21/00

(52) U.S. Cl. CPC G03G 21/0011

(57) ABSTRACT

A cleaning unit includes a housing having an opening portion, a cleaning member configured to remove developer from the image bearing member, a conveying member configured such that the developer removed by the cleaning member is conveyed from the opening portion side to a deep side of the housing, and a driving unit connected to the conveying member and configured to cause the conveying member to reciprocate such that maximum acceleration of movement of the conveying member in a direction from the opening portion side to the deep side is smaller than that in a direction from the deep side to the opening portion side. The conveying member includes a separation portion that separates the developer and a foreign substance from each other.

### BACKGROUND OF THE INVENTION

### Field of the Invention

The present invention relates to a cleaning unit, a cartridge, and an image forming apparatus, and in particular, relates to an electrophotographic image forming apparatus and a cartridge and a cleaning unit that are used in the electrophotographic image forming apparatus.

### Description of the Related Art

Some known electrophotographic image forming apparatuses are configured such that, after an image forming operation, developer remaining on the surface of a photosensitive drum is collected, a foreign substance including paper dust is separated from the collected developer, and the resultant developer is reused for efficient use of resources and environmental protection. Japanese Patent Laid-Open No. 7-129052 discloses a configuration in which developer collected from a photosensitive drum and containing a foreign substance is separated by using a mesh filter.

The configuration disclosed in Japanese Patent Laid-Open No. 7-129052 needs and further includes a plurality of magnetic sleeves to convey the separated developer, from which the foreign substance has been separated by using the mesh filter. Disadvantageously, such a configuration is complex.

### SUMMARY OF THE INVENTION

The present invention has been made to overcome the above-described disadvantages and aims to provide a cleaning unit, a cartridge, and an image forming apparatus that achieve conveyance and separation of developer containing a foreign substance with a simple configuration.

According to an aspect of the present invention, a cleaning unit includes a housing having an opening portion to which an image bearing member for bearing a developer image is attached, a cleaning member attached to the opening portion and configured to remove developer from a surface of the image bearing member, a conveying member having an upper surface and configured such that the developer, removed from the surface of the image bearing member by the cleaning member, is loaded on the upper surface of the conveying member and conveyed by the conveying member from the opening portion side to a deep side of the housing, the deep side being opposite to the opening portion side in the housing, and a driving unit connected to the conveying member and configured to cause the conveying member to reciprocate in a surface direction along the upper surface of the conveying member such that maximum acceleration of movement of the conveying member in a direction from the opening portion side to the deep side is smaller than that in a direction from the deep side to the opening portion side. The conveying member includes a separation portion that separates the developer and a foreign substance from each other.

According to another aspect of the present invention, a cartridge includes the image bearing member and the cleaning unit. The cartridge is attachable to and detachable from a main body of an image forming apparatus.

According to another aspect of the present invention, an image forming apparatus includes a transfer member and any one of the cleaning unit and the cartridge.

Further features of the present invention will become apparent from the following description of exemplary embodiments with reference to the attached drawings.

### BRIEF DESCRIPTION OF THE DRAWINGS

FIG. 1 is a schematic cross-sectional view of an image forming apparatus according to a first embodiment of the present invention.

FIG. 2 is a schematic cross-sectional view of a process cartridge used with the image forming apparatus according to the first embodiment of the present invention.

FIG. 3 is a schematic cross-sectional view illustrating a cleaning unit used with the image forming apparatus in the first embodiment of the present invention.

FIG. 4 is an exploded perspective view illustrating the cleaning unit in the first embodiment of the present invention.

FIG. 5 illustrates determination results for the first embodiment of the present invention and Comparative Example.

FIG. 6 is a schematic cross-sectional view of a process cartridge used with an image forming apparatus according to a second embodiment of the present invention.

FIG. 7 is a schematic cross-sectional view of a process cartridge used with an image forming apparatus according to a third embodiment of the present invention.

FIG. 8 is a schematic cross-sectional view of an image forming apparatus according to the third embodiment of the present invention.

### DESCRIPTION OF THE EMBODIMENTS

The present invention can be embodied in the form of any of an image forming apparatus, a cartridge constituting part of the image forming apparatus, and a cleaning unit constituting part of the image forming apparatus or the cartridge.

An electrophotographic image forming apparatus according to an embodiment of the present invention will be described below with reference to the drawings. The following embodiments are illustrative of the present invention. It should be noted that dimensions, materials, shapes, and relative arrangement of components described herein are not intended to limit the scope of the present invention unless otherwise specified.

The electrophotographic image forming apparatus forms an image on a recording medium by using an electrophotographic image forming process. Examples of the electrophotographic image forming apparatus include an electrophotographic copying machine, an electrophotographic printer (e.g., a laser beam printer or a light-emitting diode (LED) printer), a facsimile machine, and a word processor.

The cartridge constituting part of the image forming apparatus can include either one of a (photosensitive) drum cartridge and a process cartridge. These cartridges are attachable to and detachable from a main body of the electrophotographic image forming apparatus.

The drum cartridge includes at least an image bearing member (photosensitive drum). The process cartridge is an integrated combination of a photosensitive drum and at least one processing unit, such as a charging unit, a developing unit, or a cleaning unit. For example, the photosensitive drum and the developing unit may be combined into a cartridge.

In the following description, the longitudinal direction of the cartridge is the axial direction of the image bearing member.

### First Embodiment

### (1) Image Forming Apparatus

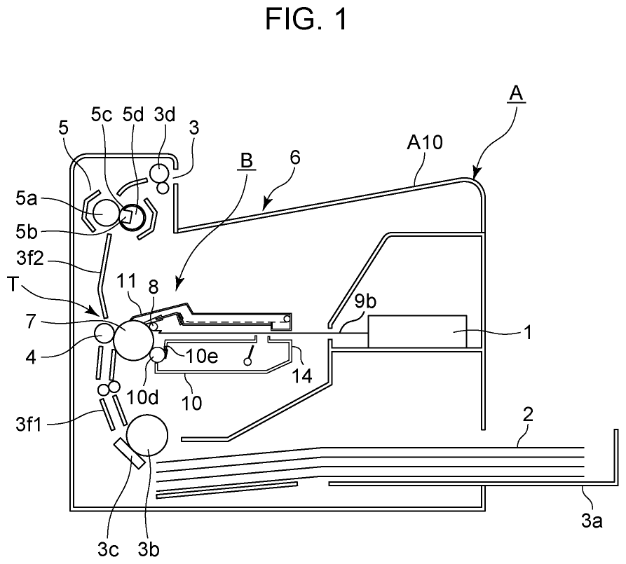

An exemplary overall configuration of an electrophotographic image forming apparatus A (hereinafter, referred to as an “image forming apparatus A”) will be described with reference to FIG. 1.

FIG. 1 is a schematic cross-sectional view of an image forming apparatus according to a first embodiment of the present invention. Specifically, FIG. 1 schematically illustrates the image forming apparatus A with a cartridge B according to the first embodiment attached thereto. FIG. 1 illustrates a laser beam printer, which is an example of the image forming apparatus A according to the first embodiment of the present invention.

As illustrated in FIG. 1, the image forming apparatus A (laser beam printer) includes a main body A10 and the cartridge B, which is detachable from the main body A 10 of the apparatus A. A photosensitive drum 7, serving as an image bearing member, is disposed in the main body A10 of the apparatus A.

The image forming apparatus A applies information light based on image information and emitted from an optical system 1, serving as an optical unit (optical device), to a surface 71 of the photosensitive drum 7 as a drum-shaped member, thus forming an electrostatic latent image on the photosensitive drum 7, or the surface 71 thereof. The electrostatic latent image is developed with developer (hereinafter, referred to as “toner”), thus forming a toner image. In synchronization of formation of the toner image, recording media (e.g., recording sheets, overhead projector (OHP) sheets, or cloth) 2 are separated and fed one by one from a cassette 3a by a pickup roller 3b and a pressing member 3c pressed against the pickup roller 3b.

The fed recording medium 2 is conveyed along a conveyance guide 3f1 to a transfer portion T in which the photosensitive drum 7 of the cartridge B faces a transfer roller 4, serving as a transfer member. In the transfer portion T, the toner image on the photosensitive drum 7 is transferred to the conveyed recording medium 2 by the transfer roller 4 to which voltage is applied. The recording medium 2 with the toner image is conveyed along a conveyance guide 3f2 to a fixing device 5.

The fixing device 5 includes a driving roller 5a and a fixing rotation member 5c, which is a hollow cylindrical sheet having therein a heater 5b and rotatably supported by a support 5d. The fixing device 5 applies heat and pressure to the recording medium 2 passing therethrough, thus fixing the transferred toner image.

A discharge roller 3d is configured to convey the recording medium 2 with the fixed toner image and discharge the recording medium 2 to a discharge portion 6 through a reversal conveyance path. In this embodiment, the pickup roller 3b, the pressing member 3c, the discharge roller 3d are included in a conveying device 3.

### (2) Process Cartridge (Cartridge)

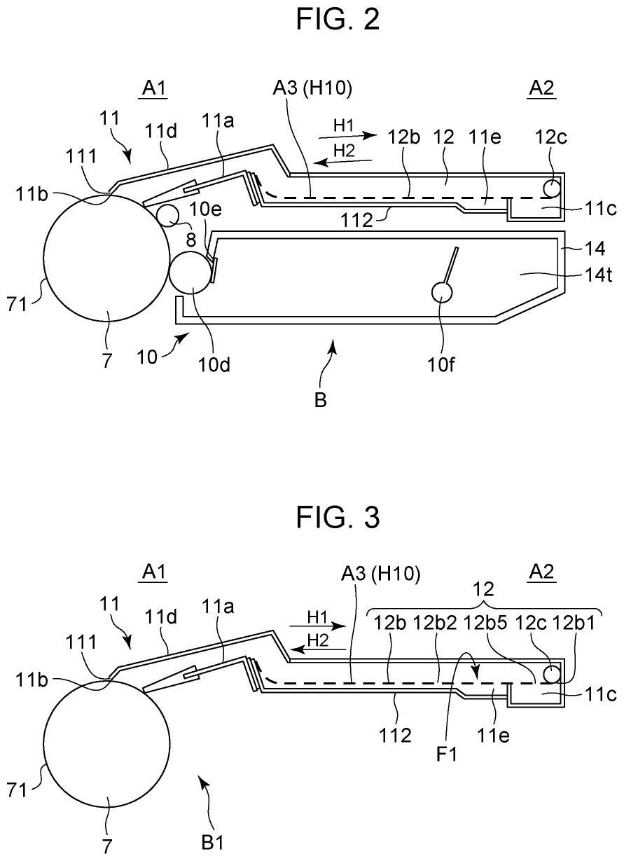

An exemplary configuration of the cartridge B (process cartridge) will now be described with reference to FIG. 2.

FIG. 2 is a schematic cross-sectional view of the process cartridge used with the image forming apparatus according to the first embodiment of the present invention. FIG. 2 schematically illustrates a cross-section of the cartridge B.

As illustrated in FIG. 2, the cartridge B includes the photosensitive drum 7 and at least one processing unit. Examples of the processing units include a charging unit to charge the photosensitive drum 7, a developing unit to develop an electrostatic latent image formed on the photosensitive drum 7, and a cleaning unit to remove toner remaining on the photosensitive drum 7.

In this embodiment, a cleaning unit 11 includes, as main components, a cleaning blade 11a as a cleaning member, a toner conveying member 12b as a (developer) conveying member, a conveyance shaft 12c, and a cleaning housing 11d. The cleaning unit 11 further includes a collected toner storage portion 11e (first storage portion), serving as a developer storage portion to store the toner removed from the photosensitive drum 7, and a sweeper strip 11b. The photosensitive drum 7 is rotatably supported at an opening portion, or on an opening portion side Al, of the cleaning housing 11d. As shown in this embodiment, the photosensitive dram 7 and a charging roller 8 are able to be provided on the cleaning unit 11 as well.

A developing unit 10 includes a development roller 10d (developer bearing member), a development blade 10e, and a container 14 (development housing) incorporating a stirring member 10f. The container 14 contains the toner in a toner storage portion 14t (internal space) inside the container.

In the embodiment, as illustrated in FIG. 2, the toner conveying member 12b (conveying member) conveys the toner in a developer conveyance direction (movement direction H1) from the cleaning blade 11a (opening portion side A1) to a foreign substance storage portion 11c (deep side A2). A direction opposite to the developer conveyance direction is a movement direction H2. As will be described later, the toner conveying member 12b has an upper surface A3 extending in a surface direction H10. The toner conveying member 12b reciprocates in the surface direction H10. For the toner and a foreign substance on the upper surface A3, the toner and the foreign substance can be conveyed in a predetermined direction (direction H1) depending on the difference between maximum acceleration of the toner conveying member 12b in the direction H1 and that in the direction H2.

The cartridge B includes the cleaning unit 11 and the developing unit 10.

### (3) Image Forming Process

An image forming process of the cartridge B will now be described.

The photosensitive drum 7 including a photosensitive layer is rotated. Voltage is applied to the charging roller 8, serving as a charging unit, to uniformly charge the surface of the photosensitive drum 7. The charged photosensitive drum 7 is exposed to information light (optical image) based on image information and applied from the optical system 1 through an exposure opening 9b, so that an electrostatic latent image is formed on the surface of the photosensitive drum 7. The electrostatic latent image is developed by the developing unit 10. The developing unit 10 is a developing device.

The developing unit 10 rotatably supports the development roller 10d, serving as a developer bearing member that bears the developer. In synchronization with the rotation, a toner layer triboelectrically charged by the development blade 10e is formed on the surface of the development roller 10d, and the toner is transferred to the electrostatic latent image on the photosensitive drum 7, thus forming a toner image as a visible image.

The toner image is transferred from the photosensitive drum 7 to a recording medium 2 by applying voltage opposite in polarity to the toner image to the transfer roller 4. After that, the toner remaining on the photosensitive drum 7 is scraped by the cleaning blade 11a fixed to the cleaning housing 11d in FIG. 2. Furthermore, the toner is picked up by the sweeper strip 11b and is collected into the collected toner storage portion 11e (first storage portion) by the toner conveying member 12b. These components included in the cleaning unit remove the residual toner on the photosensitive drum 7.

### (4) Cleaning Unit and Toner Conveying and Separating Mechanism

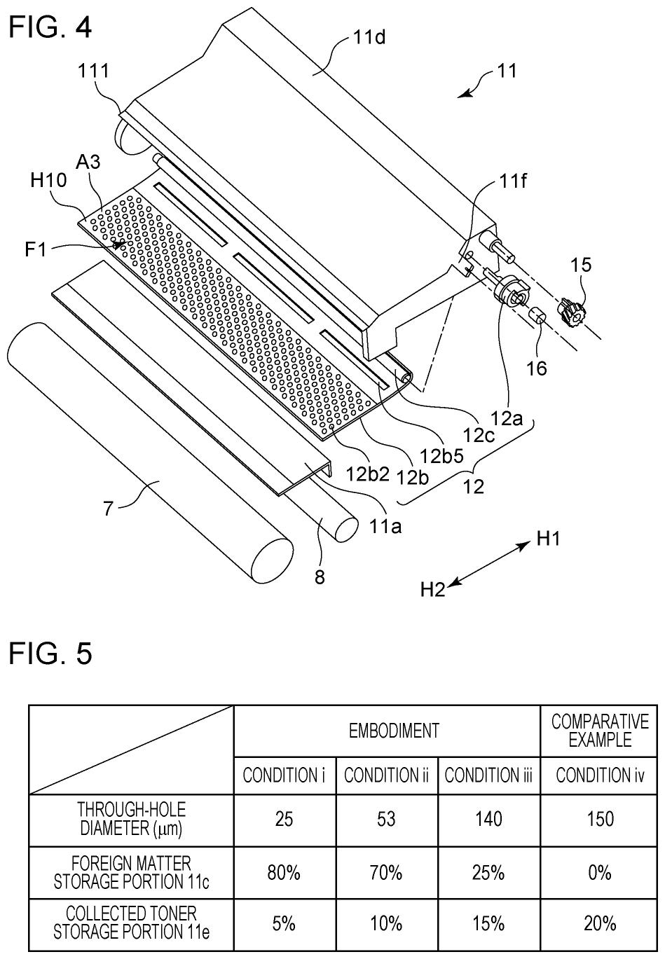

An exemplary configuration of the cleaning unit 11 and that of a toner conveying and separating mechanism 12 will now be described in detail with reference to FIGS. 3 and 4.

FIG. 3 is a schematic cross-sectional view illustrating the cleaning unit used with the image forming apparatus in the first embodiment of the present invention. The cleaning unit in FIG. 3 constitutes part of the process cartridge of FIG. 2. FIG. 4 is an exploded perspective view illustrating the cleaning unit in the first embodiment of the present invention.

As illustrated in FIG. 3, the cleaning unit 11 includes, as main components, the cleaning blade 11a, the toner conveying and separating mechanism 12, the cleaning housing 11d, the foreign substance storage portion 11c (second storage portion), and the collected toner storage portion 11e (first storage portion). The cleaning housing has an opening portion 111, in which the sweeper strip 11b is disposed, and a bottom 112 on which the collected toner storage portion 11e is disposed. As shown in this embodiment, the photosensitive dram 7 and the charging roller 8 are able to be provided on the cleaning unit 11 as well.

As illustrated in FIG. 4, the toner conveying and separating mechanism 12 includes the toner conveying member 12b (conveying member), the conveyance shaft 12c, a rotary member 12a as a member to be operated, a rotating member 15 as an operating member, and a spring member 16.

A driving mechanism of the toner conveying member 12b will now be described with reference to FIG. 4. As illustrated in FIG. 4, the cleaning housing 11d has an outer wall with the rotary member 12a to rotate the conveyance shaft 12c, to which the toner conveying member 12b is fastened. In addition, the cleaning housing 11d includes the rotating member 15 to drive the rotary member 12a in response to receiving a driving force from the main body A10 of the apparatus A and a fixing portion 11f that fixes the spring member 16 attached to the rotary member 12a. The spring member 16, which is a torsion coil spring, is attached to the rotary member 12a.

The rotating member 15 is constructed by a multi-stage gear and a tooth-missing gear having a tooth missing part. The multi-stage gear includes a gear portion that receives a driving force for continuous rotation from a driving force transmission gear (not illustrated) disposed in the main body A10 of the apparatus A. Rotation of the rotating member 15 causes the tooth-missing gear to operate the rotary member 12a, thus accelerating the rate of movement of the toner conveying member 12b reciprocating in the movement directions H1 and H2 via the conveyance shaft 12c. This vibrates the toner conveying member 12b. In the embodiment, acceleration in the direction H2 is set larger than that in the direction H1. This allows the toner contacting the upper surface and a lower surface of the toner conveying member 12b to be conveyed into the collected toner storage portion 11e. In the embodiment, the rotating member 15 is rotated at 300 rpm, a force applied to the rotary member 12a by the rotating member 15 has a frequency of 30 Hz, and the rotary member 12a is rotated at an angle of 30° when operated by the rotating member 15.

An exemplary configuration of the toner conveying member 12b in FIG. 4 will now be described. The toner conveying member 12b is a sheet-like member used to convey the toner and separate the foreign substance from the toner. The toner conveying member 12b is configured as a sheet member having a thickness of 0.1 mm and has a plurality of through-holes 12b2 located above at least the collected toner storage portion 11e. Each through-hole has a diameter larger than that of the toner. The toner conveying member 12b is fixed at a fixed end 12b1 (refer to FIG. 3), which is one end of the sheet member, to the conveyance shaft 12c connected to the rotary member 12a, which will be described later. Each through-hole 12b2 is a circular hole having a diameter of 25 μm.

The through-holes 12b2 in the embodiment are included in a separation portion F1 in the present invention.

The toner conveying member 12b is in contact with an inner wall of the cleaning housing 11d and is thus curved so that the toner collected by the cleaning blade 11a is placed on the toner conveying member 12b. The toner conveying member 12b further has communicating holes 12b5 through which the foreign substance contained in the toner on the upper surface A3 of the toner conveying member 12b is received into the foreign substance storage portion 11c. The toner passes downward through the through-holes 12b2 of the toner conveying member 12b and is received into the collected toner storage portion 11e. An example of the toner conveying member 12b is a polystyrene (PS) sheet having a thickness of 0.1 mm. The toner conveying member 12b can be made of another flexible material, such as polyethylene terephthalate (PET) or polyethylene (PE). Examples of the material for the toner conveying member 12b are not limited to the above-described materials.

In addition to the through-holes 12b2, the communicating holes 12b5 in the embodiment are included in the separation portion F1 in the present invention. Only the through-holes 12b2 can constitute the separation portion F1.

### (5) Principle of Separation of Foreign Substance in Toner Conveying and Separating Mechanism

The principle of separation of a foreign substance in the embodiment will now be described. Specifically, the relationship between the size of each through-hole 12b2, the ease of conveyance of the toner, and the separativeness of the toner from the foreign substance will be described in detail.

As described above, the toner collected by the cleaning blade 11a is placed on the toner conveying member 12b, and the toner conveying member 12b experiences vibrations with acceleration, so that the toner is separated and conveyed. The collected toner on the toner conveying member 12b passes through the through-holes 12b2 arranged in the toner conveying member 12b, or falls downward from the toner conveying member 12b, because the toner has a smaller diameter than the through-holes 12b2. After that, the toner is affected by vibrations with acceleration of the toner conveying member 12b, so that the toner is conveyed to and received into the collected toner storage portion 11e. The foreign substance having a larger diameter than the through-holes 12b2 do not fall from the toner conveying member 12b. The foreign substance is conveyed by vibrations with acceleration of the toner conveying member 12b, passes through the communicating holes 12b5, and is then received into the foreign substance storage portion 11c.

The separativeness can be adjusted by changing the size of each through-hole based on the difference in size between the toner and the foreign substance. Assuming that the toner has a diameter of 5 μm and the foreign substance has a diameter of 20 μm, the through-holes may have a diameter of approximately 15 μm such that each through-hole is larger than the toner and is smaller than the foreign substance. Thus, the toner and the foreign substance can be separated from each other. Considering clogging of the through-holes, the through-holes may have a larger diameter. However, if the through-holes have a larger diameter than the foreign substance, the foreign substance passing downward through the conveying member will increase in number, leading to lower separativeness.

For the ease of conveyance, since the toner is conveyed by the difference in acceleration between the conveying member and the toner, the conveying member may have a smaller number of through-holes and little unevenness so as not to obstruct movement of the toner.

Although the through-holes have a circular shape in the embodiment, the through-holes may have any other shape. The shape of the through-holes may be appropriately changed depending on a foreign substance to be separated, separativeness, or ease of conveyance. Furthermore, the through-holes may be formed by etching or punching. A mesh filter (mesh structure) may be used.

### (6) Evaluation of Effects of Separation of Foreign Substance

Effects of conveyance and separation of the foreign substance in the embodiment will now be described with reference to FIG. 5.

FIG. 5 illustrates determination results for the first embodiment of the present invention and Comparative Example.

As illustrated in FIG. 5, the through-holes 12b2 were changed in diameter and the first embodiment was compared with Comparative Example.

In this comparison, the toner conveying members 12b formed under different conditions were prepared.

The thickness of the toner conveying member 12b and the driving conditions (rotation speed and frequency) were the same as those described above. Only the size of each through-hole 12b2 was changed and the number of through-holes was adjusted to provide the same area of through-holes per unit area. Under Condition i, the diameter of each through-hole 12b2 was 25 μm. Under Condition ii, the diameter of each through-hole 12b2 was 53 μm. Under Condition iii, the diameter of each through-hole 12b2 was 140 μm. Under Condition iv (Comparative Example), the diameter of each through-hole 12b2 was 150 μm.

Toner having an average particle diameter of 6 μm and containing, as a foreign substance, 10 wt % talc having an average particle diameter of 20 μm (the ratio of toner to talc=9:1) was put into the toner conveying and separating mechanism 12 under each of the above-described conditions, and the mechanism was driven for ten seconds. The percentage of talc in the foreign substance storage portion 11c and that in the collected toner storage portion 11 e were determined under each of the conditions. FIG. 5 illustrates the results.

For a method of calculating the percentage of talc, the percentage of talc was calculated from the percentage of the area of talc to a region having a predetermined size in an image observed by using an optical microscope. In this method, the percentage of 10 wt % talc calculated from the percentage of the area of talc to the region before separation is 20%.

Under Condition i where the diameter of each through-hole was 25 μm, 80% (area percentage) of talc in the foreign substance storage portion 11c and 5% (area percentage) of talc in the collected toner storage portion 11e were observed. This condition gave good separation because the amount of talc in the foreign substance storage portion 11c is the largest and that in the collected toner storage portion 11e was the smallest among those under the conditions.

Under Condition ii where the diameter of each through-hole was 53 μm, 70% (area percentage) of talc in the foreign substance storage portion 11c and 10% (area percentage) of talc in the collected toner storage portion 11e were observed.

Under Condition iii where the diameter of each through-hole was 140 μm, 25% (area percentage) of talc in the foreign substance storage portion 11c and 15% (area percentage) of talc in the collected toner storage portion 11e were observed.

Under Conditions ii and iii, the toner and the talc were successfully separated in the foreign substance storage portion 11c. Although the amount of talc in the collected toner storage portion 11e under each of these conditions is slightly larger than that under Condition i, the toner separated under each of these conditions can be recycled as developer.

Under Condition iv where the diameter of each through-hole was 150 μm, neither talc nor toner were observed in the foreign substance storage portion 11c and 20% (area percentage) of talc (substantially unseparated from toner particles) was observed in the collected toner storage portion 11e.

Specifically, under this condition, separated talc was not observed in the foreign substance storage portion 11c and only the collected toner storage portion 11e contained unseparated particles of toner and talc. The reason can be thought as follows. Since the through-holes 12b2 were too larger than the toner and the talc, both the toner and the talc passed through the through-holes 12b2 and the separation failed.

Therefore, the foreign substance was successfully conveyed and separated under Conditions i to iii, whereas the conveyance and separation of the foreign substance failed under Condition iv, or in Comparative Example.

As described above, the diameter of the through-holes 12b2 is made larger than that of the toner and is made less than 150 μm, thus achieving the separation and conveyance of the foreign substance. The cleaning unit in which the separation and conveyance of the foreign substance are achieved in this manner can be provided.

In other words, in a fine-particles conveying apparatus including a conveying member to be vibrated, the conveying member has holes having a diameter larger than developer and less than 150 μm and functions to separate a foreign substance and the developer from each other by using the holes. Thus, the separation and conveyance of the foreign substance contained in the developer can be achieved simultaneously.

### Second Embodiment

An exemplary configuration in a second embodiment is basically the same as that in the first embodiment. The second embodiment differs from the first embodiment mainly in the collected toner storage portion. The other components in the second embodiment are basically the same as those in the first embodiment. The second embodiment offers the same advantages as those of the first embodiment.

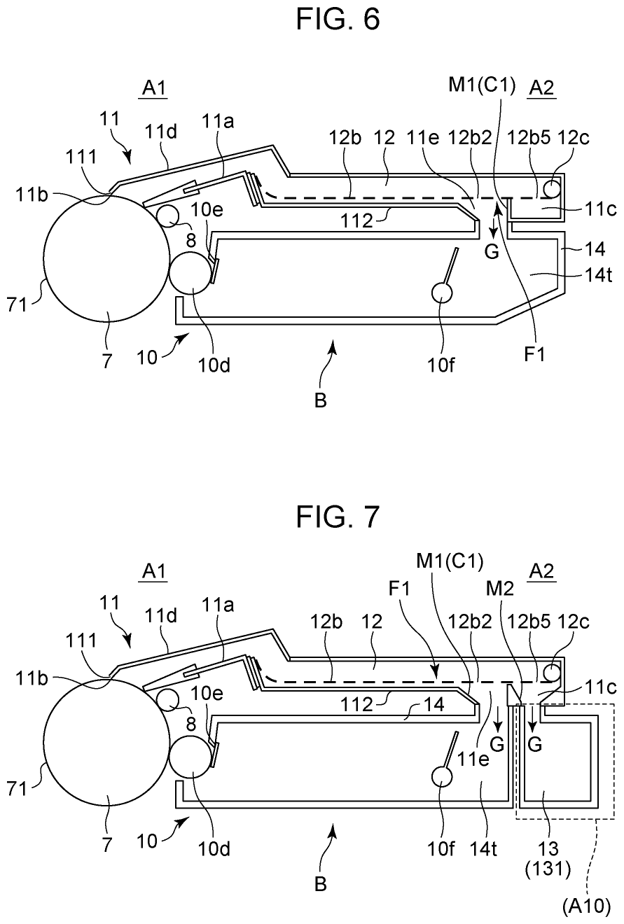

An exemplary configuration of a collected toner storage portion in the second embodiment will be described below with reference to FIG. 6.

FIG. 6 is a schematic cross-sectional view of a process cartridge used with an image forming apparatus according to the second embodiment of the present invention.

In this embodiment, the process cartridge includes a first conveying mechanism M1 to convey developer, separated by the separation portion F1, from the cleaning unit 11 to the developing unit 10.

For example, a discharge portion C1 can be disposed under the collected toner storage portion 11e in a gravitational direction G so that collected toner directly falls or is supplied into the toner storage portion 14t of the developing unit 10 located under the discharge portion C1. Furthermore, another conveying member (not illustrated) and another conveyance path (not illustrated) may be arranged to supply collected toner to the developing unit 10. The first conveying mechanism M1 may be configured as the discharge portion C1.

Specifically, the second embodiment features the location of the developing unit 10 just under the cleaning unit 11 and a communicating hole (discharge portion C1) through which the collected toner storage portion 11e communicates with the toner storage portion 14t.

In the above-described first embodiment, the separated toner is received in the collected toner storage portion 11e. In contrast, the second embodiment provides a configuration in which, as illustrated in FIG. 6, the separated toner is returned to the toner storage portion 14t, which is used for development, without being accumulated in the collected toner storage portion 11e.

Thus, a cartridge with a small and simple configuration in which toner is recycled without using any complicated mechanism can be provided.

### Third Embodiment

An exemplary configuration in a third embodiment is basically the same as that in the first embodiment. The third embodiment differs from the first embodiment mainly in the foreign substance storage portion. The other components in the third embodiment are basically the same as those in the first or second embodiment. The third embodiment offers the same advantages as those of the first or second embodiment.

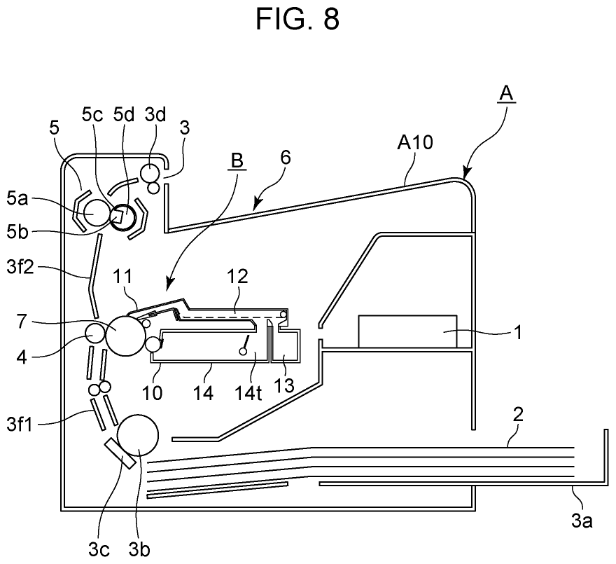

An exemplary configuration of a foreign substance storage portion in the third embodiment will be described below with reference to FIGS. 7 and 8.

FIG. 7 is a schematic cross-sectional view of a process cartridge used with an image forming apparatus according to the third embodiment of the present invention. FIG. 8 is a schematic cross-sectional view of an image forming apparatus according to the third embodiment of the present invention.

In the third embodiment, the process cartridge includes a second conveying mechanism M2 to convey a foreign substance, separated by the separation portion F1, from the cleaning unit 11 to the developing unit 10. The development housing 14 of the developing unit 10 includes a third storage portion 13 to store the foreign substance conveyed by the second conveying mechanism M2.

In this embodiment, the third storage portion 13 is included in the development housing 14 (developing unit 10). A component similar to the third storage portion 13 may be included in the main body A10 of the apparatus, instead of the developing unit 10. For example, the main body A10 of the apparatus may include a fourth storage portion 131.

Furthermore, only the foreign substance storage portion (third storage portion 13) can be replaced if the foreign substance storage portion is a separate component that is attachable to and detachable from the main body of the image forming apparatus.

Consequently, each cartridge (or unit) can be further reduced in size and increased in service life.

Configurations according to embodiments of the present invention can be summarized as follows.

A cleaning unit (11) according to an embodiment of the present invention includes a housing (11d) having an opening portion (111) to which an image bearing member (7) for bearing a developer image is attached. The unit further includes a cleaning member (11a) attached to the opening portion and configured to remove developer from a surface (71) of the image bearing member. The unit further includes a conveying member (12b) having an upper surface (A3), and the conveying member is configured such that the developer, removed from the surface of the image bearing member by the cleaning member, is loaded on the upper surface of the conveying member and conveyed by the conveying member from the opening portion side (A1) to a deep side (A2) of the housing, the deep side being opposite to the opening portion side in the housing. The unit further includes a driving unit (15) configured to cause the conveying member to reciprocate in a surface direction (H10) along the upper surface of the conveying member. The driving unit is connected to the conveying member and is configured to drive the conveying member such that maximum acceleration of movement of the conveying member in a direction (H1) from the opening portion side to the deep side is smaller than that in a direction (H2) from the deep side to the opening portion side. The conveying member includes a separation portion (F1) that separates the developer and a foreign substance from each other.

In the cleaning unit according to the embodiment of the present invention, the separation portion (F1) can include a plurality of through-holes (12b2) extending through the conveying member in a direction along a thickness of the conveying member and having a diameter of less than 150 μm.

In the cleaning unit according to the embodiment of the present invention, the housing (11d) may include a first storage portion (11e) in which the developer separated by the separation portion (F1) is stored.

In the cleaning unit according to the embodiment of the present invention, the first storage portion (11e) may include a discharge portion (C1) through which the developer stored in the first storage portion is discharged to an outside of the housing.

In the cleaning unit according to the embodiment of the present invention, the discharge portion (C1) can communicate with an internal space (14t) of a development housing (14) that holds a developer bearing member bearing the developer. The developer separated by the separation portion (F1) may be supplied to and reused in a developing unit (10), in which the developer bearing member (10d) and the development housing (14) are provided.

In the cleaning unit according to the embodiment of the present invention, in a posture in use, the first storage portion (11e) may be disposed on a bottom (112) of the housing, and the developer in the first storage portion may be discharged downward in a gravitational direction (G) through the discharge portion and supplied into the development housing (14).

In the cleaning unit according to the embodiment of the present invention, the separation portion (F1) may be located on the deep side (A2) in the housing.

In the cleaning unit according to the embodiment of the present invention, the housing (11d) may include a second storage portion (11c) in which the foreign substance separated by the separation portion (F1) is stored.

The cleaning unit according to the embodiment of the present invention may be attachable to and detachable from a main body (A10) of an image forming apparatus (A).

In the cleaning unit according to the embodiment of the present invention, the separation portion (F1) can include a mesh structure. The mesh structure can have a mesh size of 15 to 150 μm and a line width of 15 to 100 μm.

A cartridge (drum cartridge) (B1) according to an embodiment of the present invention includes an image bearing member (7) and the cleaning unit (11), and is attachable to and detachable from a main body of an image forming apparatus.

The cartridge (process cartridge) (B) according to the embodiment of the present invention may further include a developing unit (10) including a developer bearing member (10d) that bears developer and a development housing (14) that holds the developer bearing member.

The cartridge (B) according to the embodiment of the present invention may include a first conveying mechanism (M1) configured to convey the developer, separated by the separation portion (F1), from the cleaning unit (11) to the developing unit (10).

The cartridge (B) according to the embodiment of the present invention may include a second conveying mechanism (M2) configured to convey the foreign substance, separated by the separation portion (F1), from the cleaning unit (11) to the developing unit (10). In the cartridge, the development housing of the developing unit may include a third storage portion (13) to store the foreign substance conveyed by the second conveying mechanism.

An image forming apparatus (A) according to an embodiment of the present invention includes a transfer member (4) and any one of the cleaning unit (11) and the cartridge (B1, B).

The image forming apparatus (A) according to the embodiment of the present invention may further include a main body (A10). The main body (A10) may include a fourth storage portion (131) to store the foreign substance separated by the separation portion (F1).

Each of the cleaning unit, the cartridge, and the image forming apparatus according to the embodiments of the present invention simultaneously achieves conveyance and separation of developer containing a foreign substance with a simple configuration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-068045, filed Mar. 29, 2019, which is hereby incorporated by reference herein in its entirety.

1. A cleaning unit comprising:
a housing having an opening portion to which an image bearing member for bearing a developer image is attached;
a cleaning member attached to the opening portion and configured to remove developer from a surface of the image bearing member;
a conveying member having an upper surface, the conveying member being configured such that the developer, removed from the surface of the image bearing member by the cleaning member, is loaded on the upper surface of the conveying member and conveyed by the conveying member from the opening portion side to a deep side of the housing, the deep side being opposite to the opening portion side in the housing; and
a driving unit connected to the conveying member, the driving unit being configured to cause the conveying member to reciprocate in a surface direction along the upper surface of the conveying member such that maximum acceleration of movement of the conveying member in a direction from the opening portion side to the deep side is smaller than that in a direction from the deep side to the opening portion side,
wherein the conveying member includes a separation portion that separates the developer and a foreign substance from each other.

2. The cleaning unit according to claim 1, wherein the separation portion has a plurality of through-holes, extending through the conveying member in a direction along a thickness of the conveying member, and having a diameter of less than 150 μm.

3. The cleaning unit according to claim 1, wherein the housing includes a first storage portion in which the developer separated by the separation portion is stored.

4. The cleaning unit according to claim 3, wherein the first storage portion includes a discharge portion through which the developer stored in the first storage portion is discharged to an outside of the housing.

5. The cleaning unit according to claim 4,
wherein the discharge portion communicates with an internal space of a development housing that holds a developer bearing member bearing the developer, and
wherein the developer separated by the separation portion is supplied to and reused in a developing unit, in which the developer bearing member and the development housing are provided.

6. The cleaning unit according to claim 5, wherein, in a posture in use, the first storage portion is disposed on a bottom of the housing, and the developer in the first storage portion is discharged downward in a gravitational direction through the discharge portion and supplied into the development housing.

7. The cleaning unit according to claim 1, wherein the separation portion is located on the deep side in the housing.

8. The cleaning unit according to claim 1, wherein the housing includes a second storage portion to store the foreign substance separated by the separation portion.

9. The cleaning unit according to claim 1, wherein the cleaning unit is attachable to and detachable from a main body of an image forming apparatus.

10. The cleaning unit according to claim 1,
wherein the separation portion comprises a mesh structure, and
wherein the mesh structure has a mesh size of 15 to 150 μm and a line width of 15 to 100 μm.

11. A cartridge comprising:
an image bearing member; and
the cleaning unit according to claim 1,
wherein the cartridge is attachable to and detachable from a main body of an image forming apparatus.

12. The cartridge according to claim 11, further comprising:
a developing unit including a developer bearing member that bears developer and a development housing that holds the developer bearing member.

13. The cartridge according to claim 12, further comprising:
a first conveying mechanism configured to convey the developer, separated by the separation portion, from the cleaning unit to the developing unit.

14. The cartridge according to claim 12, further comprising:
a second conveying mechanism configured to convey the foreign substance, separated by the separation portion, from the cleaning unit to the developing unit,
wherein the development housing of the development unit includes a third storage portion to store the foreign substance conveyed by the second conveying mechanism.

15. An image forming apparatus comprising:
a transfer member; and
the cleaning unit according to claim 1.

16. The image forming apparatus according to claim 15, further comprising:
a main body,
wherein the main body includes a fourth storage portion to store the foreign substance separated by the separation portion.

17. An image forming apparatus comprising:
a transfer member; and the cartridge according to claim 11.

18. The image forming apparatus according to claim 17, further comprising:
a main body,
wherein the main body includes a fourth storage portion to store the foreign substance separated by the separation portion.
